(19) United States
(12) Patent Application Publication
(10) Pub. No.: US 2009/0011241 A1
(43) Pub. Date: Jan. 8, 2009

(54) Carbon Nanoflake Compositions and Methods of Production

(75) Inventors: Mingyao Zhu, Williamsburg, VA (US); Dennis M. Manos, Williamsburg, VA (US); Ronald A. Outlaw, Williamsburg, VA (US)

Correspondence Address: WILLIAM AND MARY TECHNOLOGY TRANSFER OFFICE, 402 JAMESTOWN RD, PO BO 8795, WILLIAMSBURG, VA, 23187-8795, US

(73) Assignee: COLLEGE OF WILLIAM AND MARY, Williamsburg, VA (US)

(21) Appl. No.: 12/168,180

(22) Filed: Jul. 7, 2008

Related U.S. Application Data
(60) Provisional application No. 60/948,444, filed on Jul. 7, 2007.

(51) Int. Cl. B32B 5/16; H05H 1/24

(52) U.S. Cl. 428/402; 427/569; 977/890

(57) ABSTRACT

Novel compositions and morphologies of carbon nanoflakes are described, as well as methods for making carbon nanoflakes using a radio frequency plasma enhanced chemical vapor deposition (RF-PECVD) process. Acetylene is used as a CVD source gas. By utilizing high concentrations of acetylene in the CVD source gas at relatively low temperatures, carbon nanoflake growth rate and robustness are improved, and the resulting carbon nanoflakes have enhanced height uniformity.

### CROSS-REFERENCE TO RELATED APPLICATIONS

This application claims the benefit of and priority to U.S. Provisional Patent Application Ser. No. 60/948,444, filed Jul. 7, 2007, the entire disclosure of which is incorporated by reference herein.

### STATEMENT REGARDING FEDERALLY SPONSORED RESEARCH AND DEVELOPMENT

This invention was made with government support under Grant No. N00014-05-1-0749 awarded by the Office of Naval Research. The government has certain rights in the invention.

### FIELD OF THE INVENTION

The field of the invention relates to compositions of carbon nanostructures, and methods of making and using these compositions.

### BACKGROUND OF THE INVENTION

Graphite, diamond, diamond-like carbon, amorphous carbon, fullerenes, carbon nanotubes, and carbon nanofibers are attractive for their diverse forms and remarkable properties, and can have widespread applications in almost all mechanical, physical, chemical, electrochemical, microelectronic fields.

Work has been done to form plate-like carbon structures on the nanoscale. The first attempts used intercalation techniques to exfoliate graphite plates. While this process has had some success, it still has the significant drawbacks, such as: (1) the graphite plates exist within a wide distribution of particles of different thicknesses which can not be separated; (2) the graphite plates are contaminated by the intercalation compounds used in the exfoliation process; and (3) the graphite plates cannot be oriented on a surface to provide large specific surface area structures and freestanding nanometer edges. This makes them less than ideal for research studies and practical applications.

In U.S. patent application Ser. No. 10/574,507 (hereby incorporated by reference), Wang et al. describe carbon nanoflake compositions, including carbon nanosheet compositions (defined as carbon nanoflakes having thicknesses of 2 nm or less), as well as methods for making these compositions.

### BRIEF SUMMARY OF THE INVENTION

Herein we describe novel compositions and morphologies of carbon nanoflakes (CNF) and methods for making CNF using a radio frequency plasma enhanced chemical vapor deposition (RF-PECVD) process. Acetylene is used as a CVD source gas in the methods described herein. Prior art methods for making carbon nanoflakes via RF-PECVD processes contemplated using methane as a CVD source gas, and additionally contemplated the use of low concentrations of acetylene, at high temperatures, as a CVD source gas. Herein we describe the use of high concentrations of acetylene in the CVD source gas, which permits the desired nanoflake deposition at a reduced temperature range of 500° C. to 700° C. Under these conditions, carbon nanoflake growth can reach 15 μm per hour, a nearly ten-fold improvement over the growth rate using prior art methods. Additionally, the resulting nanoflakes have novel morphology, with enhanced uniformity of height, reduced packing density, and a more vertical orientation. Electron emission properties are improved, and the nanoflakes grown with this method, typically ½ nm-5 nm in thickness, are more robust. Importantly, this method consumes less of the thermal budget in the processing of various devices, potentially improving durability and performance.

Synthesis of CNF using the RF-PECVD process described herein can occur in a wide range of environments. Substrate temperatures are typically between 500° C. and 700° C. Chamber pressure can be maintained between about 10 mtorr and 100 mtorr. Plasma power is typically 700 W or above. Deposition time is typically between about 20 seconds and 100 minutes. In some embodiments, the deposition time is 20 minutes or less, and in some embodiments, the deposition time is 10 minutes or less. The gas flow rate may be varied over a very wide range, so long as the flow rate provides adequate gas (i.e., a carbon source) for CNF growth, and a stable, uniform plasma can be sustained at the desired rf input power level. For example, in the apparatus that was used to produce representative embodiments of the invention described below, a typical gas flow rate is approximately 5 sccm (standard cubic centimeters per minute). The CVD carbon-source gas is acetylene. The proportion of acetylene to hydrogen can vary between about 63%:37% and 100%:0%.

One embodiment of the invention provides carbon nanoflakes of substantially uniform height and having a thickness between about ½ nanometer and about 5 nanometers.

One embodiment of the invention provides a composition comprising carbon nanoflakes having specific surface areas between 100 m²/g and 1000 m²/g.

One embodiment of the invention provides a method of making carbon nanoflakes comprising forming the nanoflakes on a substrate using RF-PECVD, wherein acetylene is used as a CVD source gas, and wherein substrate temperatures range from 500° C. to 700° C.

One embodiment of the invention provides a field emitter comprising carbon nanoflakes.

One embodiment of the invention provides a catalyst support comprising carbon nanoflakes.

One embodiment of the invention provides a hydrogen storage device comprising carbon nanoflakes.

One embodiment of the invention provides a sensor comprising the nanoflakes.

One embodiment of the invention provides a blackbody absorber comprising the nanoflakes.

One embodiment of the invention provides a composite material comprising the nanoflakes.

One embodiment of the invention provides a method of making coated carbon nanoflakes comprising providing carbon nanoflakes coated with a metal coating and reacting the nanoflakes and the coating to convert the metal coating to a metal carbide, oxide, or other metal-containing-compound coating.

### BRIEF DESCRIPTION OF THE DRAWINGS

The summary above, and the following detailed description, will be better understood in view of the drawings which depict details of preferred embodiments.

FIG. 1 shows: (a) plan-view, and (b) cross-sectional-view SEM images of a CNF sample grown at 580° C., 100% C₂H₂ at 35 mTorr, and 1000 W RF for 10 minutes; and (c) plan-view, and (d) cross-sectional-view SEM images of a different sample grown at 600° C., 80% C₂H₂ in H₂ at 35 mTorr, and 1000 W RF for 10 minutes.

FIG. 2 shows: (a) high resolution transmission electron microscopic images of C₂H₂ nanoflakes directly deposited on a Cu grid at 600° C., 80% C₂H₂ in H₂ at 35 mTorr, and 1000 W RF for 10 minutes, and (b) an electron diffraction pattern from the same sample matching the pattern of polycrystalline graphite.

FIG. 3 shows a Raman spectrum from a CNF sample deposited from C₂H₂ source gas at 600° C., 80% C₂H₂ in H₂ at 35 mTorr, and 1000 W RF for 10 minutes.

FIG. 4 shows: (a) plan-view, and (b) cross-sectional-view SEM images of CNF grown for ten minutes under the following conditions: RF power of 1000 W, total gas flow rate of 5 sccm, 80% C₂H₂ in an H₂ atmosphere, and substrate temperature of 600° C.

FIG. 5 shows (a) plan-view, and (b) cross-sectional-view SEM images of CNF grown from 100% C₂H₂ under the following conditions: RF power of 1000 W, total gas flow rate of 5 sccm, and substrate temperature of 600° C. for 10 minutes.

FIG. 6 shows (a) plan-view, and (b) cross-sectional-view SEM images of CNF grown from 70% C₂H₂ in an H₂ atmosphere, and (c) plan-view, and (d) cross-sectional-view SEM images of CNF grown from 60% C₂H₂ in an H₂ atmosphere, with both CNF samples grown under the following conditions: RF power of 1000 W, total gas flow rate of 5 sccm, and substrate temperature of 600° C. for 10 minutes.

FIG. 7 shows the growth rate and D/G ratios of carbon nanoflakes as a function of acetylene concentration with other conditions fixed at 600° C. substrate temperature, 5 sccm total gas flow rate, 1000 W RF power and 10 minutes growth time.

FIG. 8 shows (a) plan-view, and (b) cross-sectional-view SEM images of CNF grown at 600° C., and (c) plan-view, and (d) cross-sectional-view SEM images of CNF grown at 580° C., with both CNF samples grown under the following conditions: RF power of 1000 W, total gas flow rate of 5 sccm, and CVD source gas composition of 100% C₂H₂.

FIG. 9 shows (a) plan-view, and (b) cross-sectional-view SEM images of CNF grown at 550° C., and (c) plan-view, and (d) cross-sectional-view SEM images of CNF grown at 500° C., with both CNF samples grown under the following conditions: RF power of 1000 W, total gas flow rate of 5 sccm, and CVD source gas composition of 100% C₂H₂.

FIG. 10 shows the growth rate and D/G ratios of carbon nanoflakes as a function of substrate temperature with other conditions fixed at 100% C₂H₂ gas composition, 5 sccm total gas flow rate, 1000 W RF power and 10 minutes growth time.

FIG. 11 shows a field emission curve from carbon nanoflakes synthesized under the following conditions: RF power of 1000 W, total gas flow rate of 5 sccm, 80% C₂H₂ in an H₂ atmosphere, and substrate temperature of 600° C. for 10 minutes.

FIG. 12 shows a field emission curve from carbon nanoflakes synthesized under the following conditions: RF power of 1000 W, total gas flow rate of 5 sccm, 100% C₂H₂, and substrate temperature of 600° C. for 10 minutes.

### DETAILED DESCRIPTION OF THE INVENTION

The embodiments of the present invention provide carbon nanoflake (CNF) compositions, methods of making these carbon nanoflake compositions, and methods of using the carbon nanoflake compositions. The CNF can come in a variety of forms as discussed in detail herein. Generally speaking, the CNF are sheet-like forms of graphite of varying dimensions.

Unless otherwise noted, the terms “a”, “an”, or “the” are not necessarily limited to one and may refer to more than one. For example, “a carbon nanoflake” may refer to two or more carbon nanoflakes. Unless otherwise noted, the term “between” followed by a number range is inclusive of the endpoints. For example, the phrase “between 1 and 1000” means 1, 1000, and anything in between those two endpoints.

Methods of Making Carbon Nanoflakes

In some embodiments, radio frequency plasma enhanced chemical vapor deposition (RF-PECVD) may be used to form CNF with or without the use of nanoparticle lithography and with or without using a growth catalyst on a substrate. Suitable RF-PECVD systems have been described in U.S. patent application Ser. No. 10/574,507. CNF can be formed on a variety of substrates without using catalyst or any special substrate preparations. Suitable substrates include, but are not limited to, Si, W, Ni, TiW, Mo, Cu, Au, Pt, Zr, Ti, Hf, Nb, Ta, Cr, 304 stainless steel, graphite, SiO₂, and Al₂O₃. The radio frequency energy may be inductively coupled, as in preferred embodiments, or capacitively coupled.

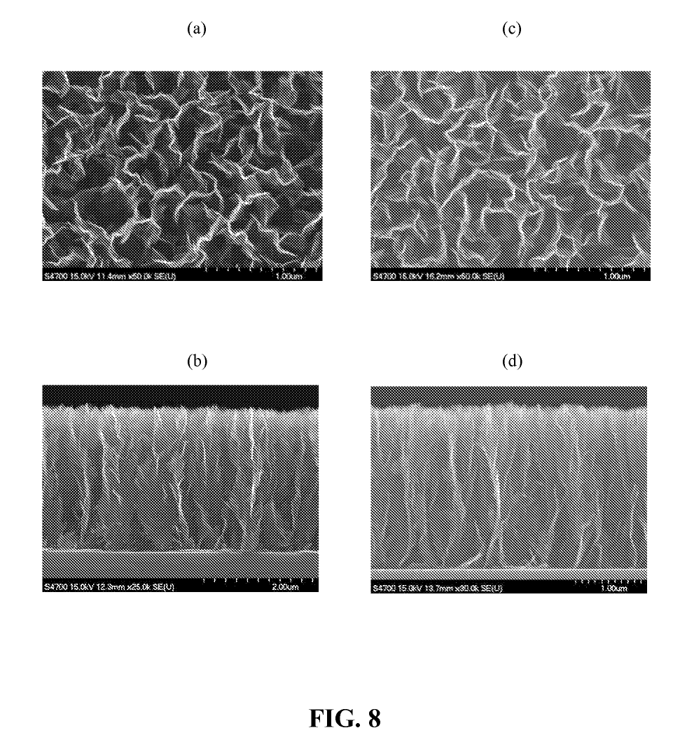

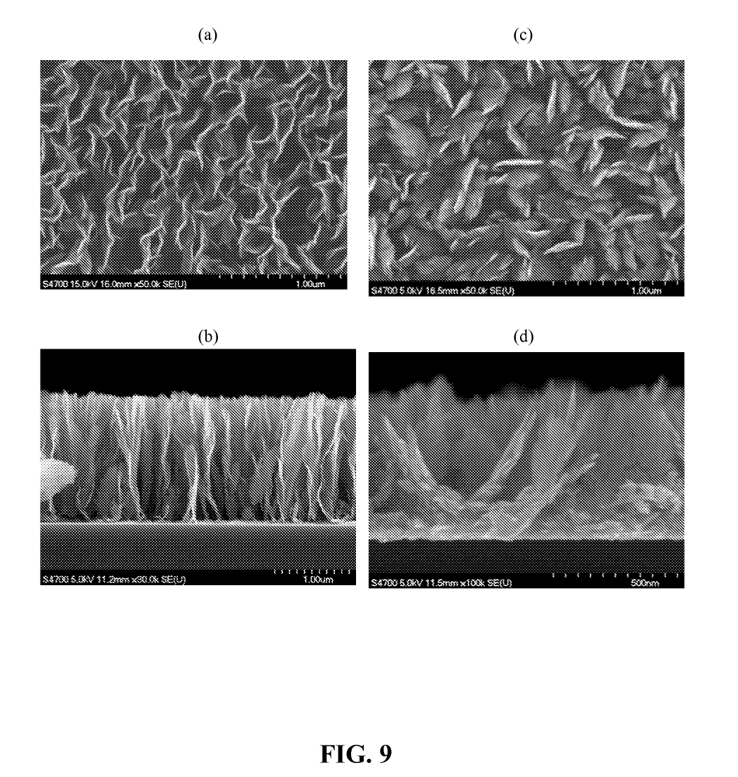

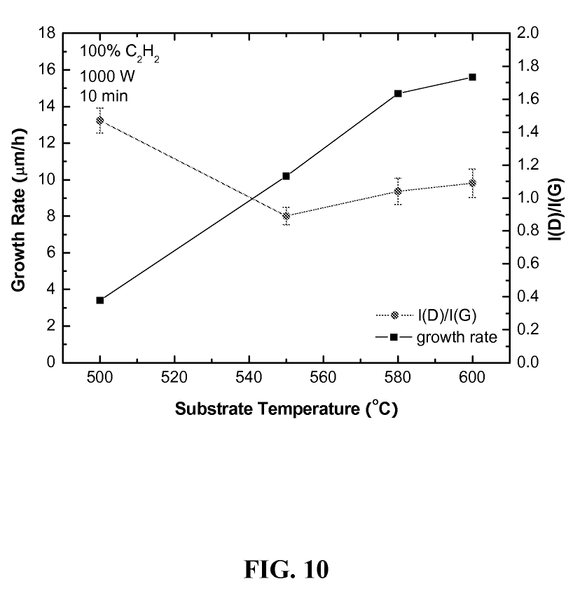

The RF-PECVD synthesis of CNF can occur in a wide range of environments. Substrate temperatures may be between 500° C. and 700° C. The effects of varying substrate temperatures on CNF morphology can be seen in FIG. 8 and FIG. 9, and the effects of varying substrate temperatures on CNF growth rate can be seen in FIG. 10. In some embodiments, the substrate temperature is between 520° C. and 650° C. Chamber pressure should be maintained between about 10 mtorr and 100 mtorr during CNF growth. In some embodiments, the chamber pressure is between 50 mtorr and 100 mtorr, such as between 70 mtorr and 90 mtorr, and in some embodiments, the chamber pressure is between 30 mtorr and 40 mtorr, such as 35 mtorr. Plasma power may be 700 W or above. In some embodiments, the plasma power is greater than 800 W, and in some embodiments, the plasma power is greater than 900 W. Deposition time may be between about 20 seconds and about 100 minutes. In some embodiments, the deposition time is 20 minutes or less, and in some embodiments, the deposition time is 10 minutes or less. The gas flow rate may be any flow rate that provides adequate gas, i.e., a carbon source, for CNF growth. Any suitable gas flow rate may be used, such as any flow rate that provides enough carbon for CNF growth. The upper end of the flow rate range is limited by how fast the pump works to maintain a desired the pressure in the chamber. A typical gas flow rate is approximate 5 sccm.

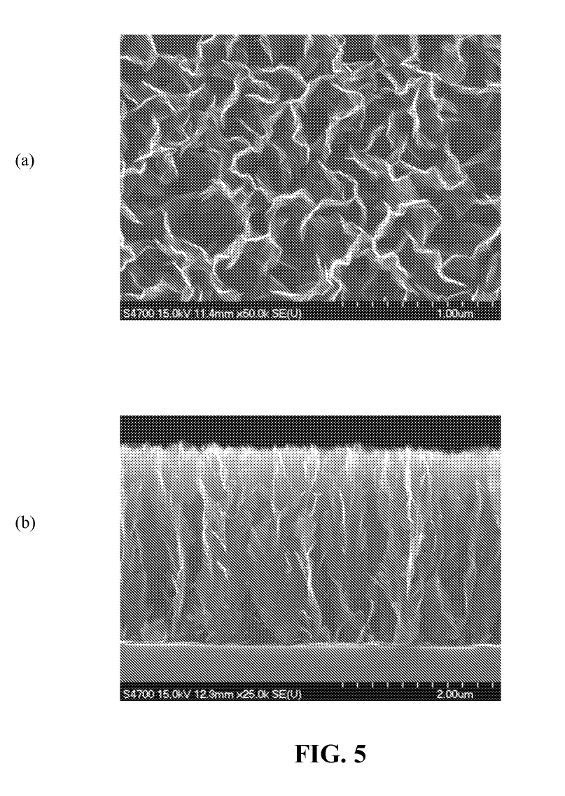

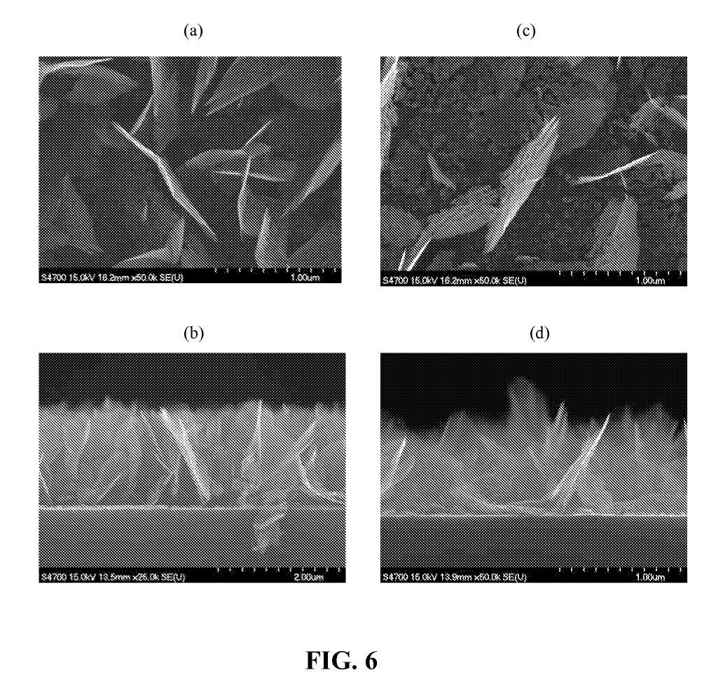

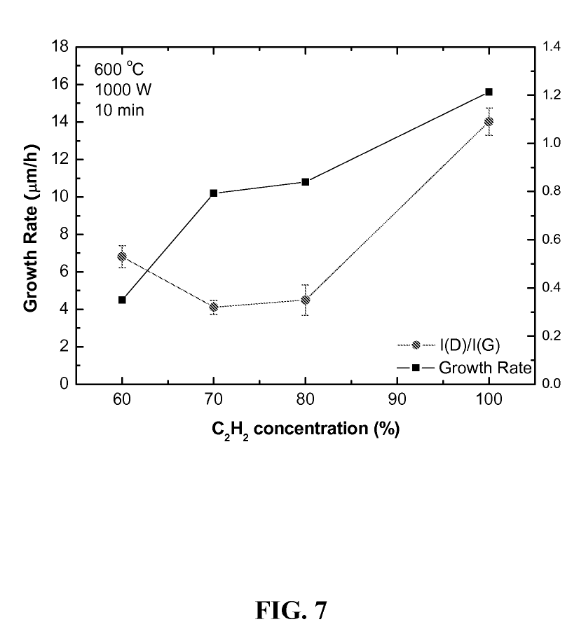

The CVD source gas comprises acetylene. The proportion of acetylene to hydrogen in the CVD source gas can vary between about 63%:37% and 100%:0%. FIG. 5 and FIG. 6 show the effects of differing concentrations of acetylene on CNF morphology, and FIG. 7 shows the effects of differing concentrations of acetylene on CNF growth rate.

In some embodiments, an electric field may be applied parallel to the substrate. This electric field may be formed by attaching a grounded electrode to the substrate, or by applying DC or time-varying electric potentials to the substrate. In some embodiments, the electric field is created by placing a vertical grounded wire or strip on the substrate. In some embodiments, multiple electrodes may be attached to the substrate to create a plurality of electric fields.

CNF may be grown on patterned substrates according to the methods of the invention. In some embodiments, DC bias is used to improve the nanostructure alignment.

Carbon-containing gases other than acetylene may be used in combination with acetylene according to the methods of the invention, provided acetylene has the highest concentration of the gases in the CVD source gas mixture. For example, methane or other carbon-bearing gases, or gasified liquids or solids entrained in the flow, can be used in combination with acetylene.

The growth rate of CNF compositions grown according to the methods of the invention depends on both the concentration of acetylene in the CVD source gas and the substrate temperature. FIG. 7 shows the growth rate of carbon nanoflakes as a function of acetylene concentration. The growth rate of CNF increases several-fold to 15.6 μm/h as the acetylene concentration in the CVD source gas is increased from 60% to 100%. FIG. 10 shows the growth rate of carbon nanoflakes as a function of substrate temperature, with growth rate increasing as the temperature is raised. The ratio of the integrated Raman signal contained in the D peak to the integrated signal contained in the G peak is a commonly accepted performance measure for graphene layers and sp² carbon materials. Lower values indicates a higher degree of crystalline order over larger crystal, or grain, domains, indicative of impurity-free sp² hexagonal carbon layers.

Carbon Nanoflakes—Structure and Characteristics

CNF refers to a broad range of carbon nanostructures. Generally, these CNF are sheet-like forms of graphite with thicknesses less than about 10 nm. The CNF compositions contemplated herein have average thicknesses ranging from about 0.5 nm to about 5 nm. Typically, the CNF compositions described herein, produced by the methods described herein, vary from about two graphene layers to about ten graphene layers. The CNF compositions of the present invention have average heights ranging from about 100 nm to up to 25 μm. One of ordinary skill in the art may desire different thicknesses and heights of CNF depending on the intended application.

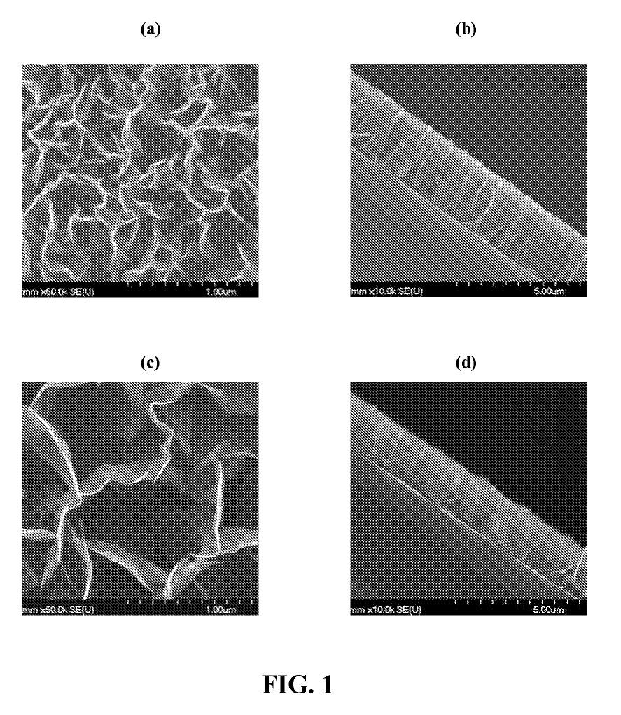

FIG. 1 shows scanning electron microscopic (SEM, Hitachi S-4700) images of two CNF samples deposited under different conditions. The first sample, shown in FIG. 1(a) and FIG. 1(b), was deposited at 580° C. substrate temperature using pure (100%) C₂H₂ gas at 35 mtorr pressure and 1000 W RF power for 10 minutes. The second sample, shown in FIG. 1(c) and FIG. 1(d), was deposited at 600° C. using 80% C₂H₂ in H₂, with all other parameters identical. Both samples have sheet-like basic structures; however, the second sample has a smoother surface morphology and a lower sheet density, which lower density may be advantageous for certain device applications. The cross-sectional view images (FIG. 1(b) and FIG. 1(d)) reveal a better alignment in the vertical direction for CNF deposited from C₂H₂ precursor gas relative to prior art samples deposited using methane as the CVD source gas. The growth rate of the first sample (i.e., the CNF sample shown in FIG. 1(a) and FIG. 1(b)) was 15 μm/hr, substantially higher than prior art methods. Furthermore, these CNF compositions of the present invention have a far more uniform height distribution than prior art CNF compositions, as quantified by the nanoflake height uniformity, which is defined as the average nanoflake height in a CNF sample divided by the standard deviation of nanoflake heights in a sample. In preferred compositions of the present invention, the nanoflake height uniformity is greater than 20, and is greater than 40 in some embodiments.

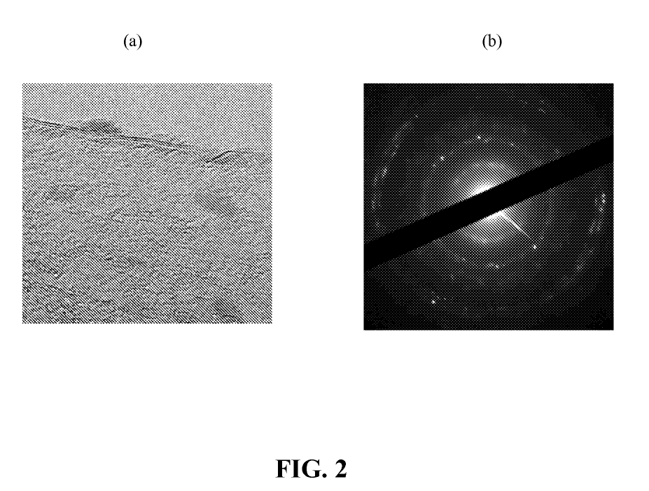

High resolution transmission electron microscope (HR-TEM, Joel 2010F) observations indicated that, like CNF structures deposited from CH₄, the CNF structures of the present invention have edges that are atomically thin (2-10 atomic layers, typically 3-5 atomic layers). FIG. 2(a) shows a high resolution transmission electron microscopic image of CNF formed from acetylene source gas and directly deposited on a copper grid. Three parallel fringes, evident in FIG. 2(a), are observed when an individual CNF folds back upon itself, and are evidence that the pictured CNF sample consists of 3 atomic layers at the edge. The electron diffraction patterns shown in FIG. 2(b) reveal a defective graphitic polycrystalline structure of the CNF compositions, similar to prior art carbon nanoflakes that were grown using CH₄ as the CVD source gas.

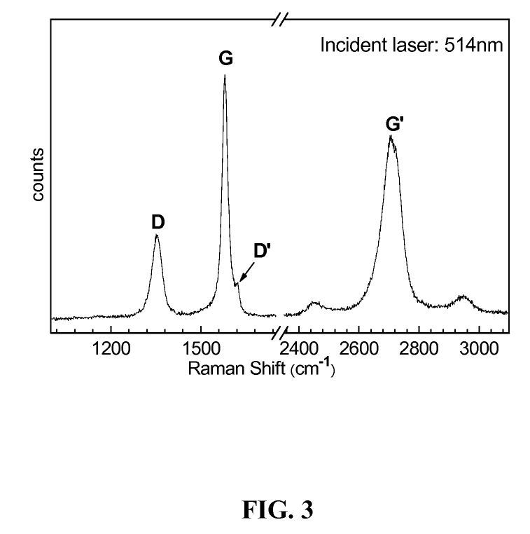

CNF compositions synthesized according to the methods of the invention were examined using Raman spectroscopy. Raman spectroscopy is a standard nondestructive tool for the structural characterization of different carbon materials. FIG. 3 shows the Raman spectra (514 nm incident laser) from carbon nanoflakes grown under the following conditions: CVD source gas 80% C₂H₂ in an H₂ atmosphere at 35 mtorr, RF power of 1000 W, total gas flow rate of 5 sccm, and substrate temperature of 600° C. The first-order G peak (1580 cm⁻¹) for ordered sp² carbon, as well as D (1352 cm⁻¹) peak and D′ shoulder (1620 cm⁻¹) for defective sp² carbon, are labeled. The overtone of D peak (2704 cm⁻¹) is also detected. The G peak indicates that the nanoflakes have a basic graphitic structure, and the D peak, D′ shoulder, and G′ peak confirm that the nanoflakes contain certain amount of defects, which is consistent with the electron diffraction results.

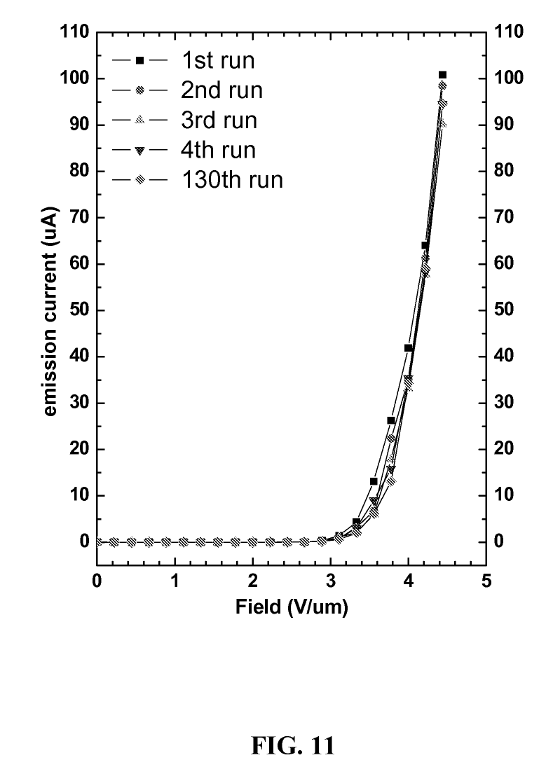

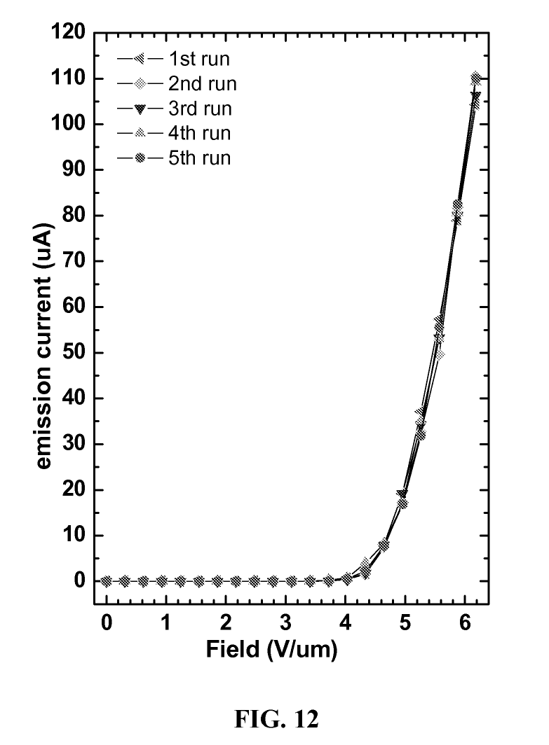

FIG. 11 shows the emission current v. electric field (E) characteristics of CNF samples grown under the following conditions: CVD source gas 80% C₂H₂ in an H₂ atmosphere, RF power of 1000 W, total gas flow rate of 5 sccm, and substrate temperature of 600° C. The turn-on field, here defined as the minimum electric field required to produce a current equal to, or exceeding, 10 μA/cm², is 3.3 V/μm. To our knowledge, this is competitive with the best values observed from carbon nanotubes and is substantially lower than most other materials. FIG. 12 shows the emission current v. electric field (E) characteristics of CNF samples grown under the following conditions: CVD source gas 100% C₂H₂, RF power of 1000 W, total gas flow rate of 5 sccm, and substrate temperature of 600° C. In these samples, the threshold field of 4.4 V/μm was slightly higher than that observed when the samples were grown from a CVD source gas composition containing 80% acetylene.

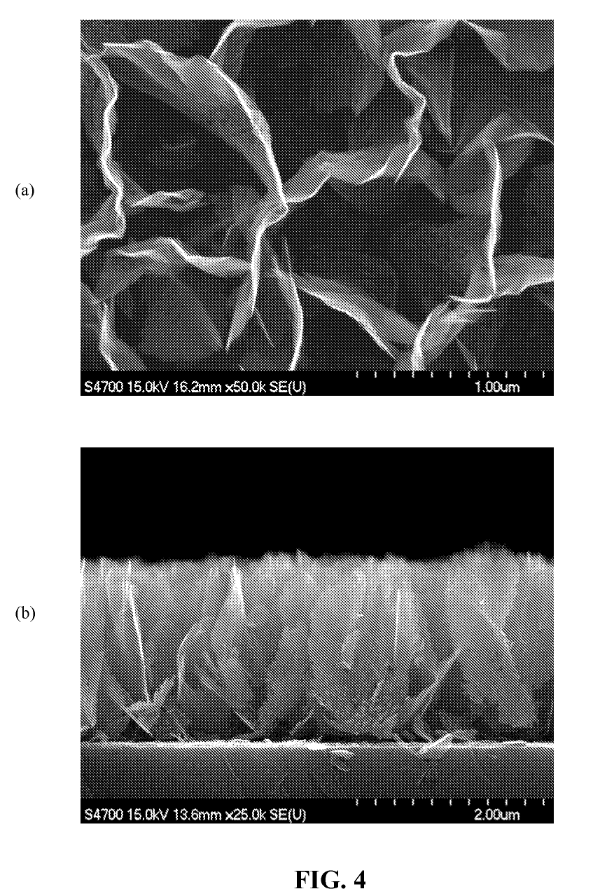

FIGS. 4, 5, 6, 8, and 9 show SEM images of CNF structures. FIG. 4 shows the characteristic low density and uniform height of CNF compositions grown according to the methods of the invention (in the embodiment depicted in FIG. 4, the CVD source gas is 80% C₂H₂ in an H₂ atmosphere, the RF power is 1000 W, the total gas flow rate is 5 sccm, and the temperature is held at 600° C.). FIG. 5 and FIG. 6 show the changes in CNF morphology based on the concentration of acetylene in the CVD source gas. At a deposition temperature of 600° C., the CNF quality decreases as the acetylene concentration in the CVD source gas drops to 70%, and drops dramatically thereafter. FIG. 8 and FIG. 9 show the changes in CNF morphology as a function of changes in the substrate temperature (while maintaining acetylene concentration in the CVD source gas at 100%). Decreasing the substrate temperature to 500° C. reduced the quality of CNF formation.

Carbon Nanoflakes—Applications

The CNF compositions of the present invention exhibit a high specific surface area. This large specific surface area makes the CNF useful for applications such as sensors, hydrogen storage, catalyst supports and other applications where high specific surface areas are considered advantageous. Considering that CNF structures can be readily grown on various types of substrates such as Si, Al₂O₃, Ni, Ti, Cu, Ag, Au (including their alloys) and stainless steel, they have great potential for sensor, catalyst support, hydrogen storage, and other high specific surface area applications.

The carbon nanoflakes of the present invention may be coated with different materials, such as metals, including Pt, Ni, Ti, Zr, Hf, V, Mo, Nb and Ta and alloys thereof and non-metals, such as ZrC and metal oxides. In one embodiment, CNF surfaces may be coated with a 1-2 nm layer of these metals, or metal oxides or alloys thereof, by electron beam evaporation.

As shown in FIG. 1, CNF compositions of the present invention have a high density of atomic scale vertical graphitic edges that are potential sites for electron field emission.

The CNF compositions of the present invention may be used in a wide variety of applications. As mentioned previously, CNF may be used for hydrogen storage, as field emitters, and as catalyst supports. In addition, CNF may be used in composite materials, such as with photoresist or polymeric materials. CNF may also be used as blackbody absorbers. The corrugated nature of CNF surfaces may serve as an excellent scatterer of infrared and visible radiation. Aligned CNF may be used to construct microfluidic devices where the CNF form the walls of the microfluidic passages. One of ordinary skill in the art would be readily able to apply CNF to additional applications.

Exemplary Synthesis of CNF Using RF-PECVD

Carbon nanoflakes were grown in an RF-PECVD system. RF (13.56 MHz) energy was inductively coupled into the deposition chamber with a 3-turn planar-coiled RF antenna (approximately 20 cm in diameter) through a quartz window. The plasma density of this inductive plasma is about 10 times greater than that that in a capacitive mode at the same RF power input. Before deposition, neither catalyst nor special substrate treatment was needed. Substrates were simply cleaned by sonicating in ethanol for several minutes and then dried in air. The resistively heated sample stage was positioned 3.5 cm below the quartz window in the center of the deposition chamber. The substrate temperature was measured by a k-type thermocouple on the upper surface. Mass flow controllers (MFC, MKS 1259B) were used to control the gas flow. During deposition, the RF power, total gas flow rate and gas pressure were kept at 1000 W, 5 sccm, and about 30-40 mTorr, respectively. Acetylene was used as the carbon source with a volume concentration range of 60-100% in an H₂ atmosphere. Substrate temperature was varied from 500° C. to 700° C. Deposition time was 10 minutes. Substrates used in this study include Si, Ni, and Cu.

Incorporation by Reference

All publications, patents, and patent applications cited herein are hereby expressly incorporated by reference in their entirety and for all purposes to the same extent as if each was so individually denoted.

Equivalents

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

We claim:

1. A carbon nanoflake composition having average nanoflake thickness between 0.5 nanometers and 5 nanometers, and nanoflake height uniformity of greater than 20.

2. The carbon nanoflake composition of claim 1, wherein the nanoflake height uniformity is greater than 40.

3. The carbon nanoflake composition of claim 1, wherein the carbon nanoflake composition has an average height between about 100 nm and 8 μm.

4. The carbon nanoflake composition of claim 1, wherein the nanoflakes are freestanding nanoflakes disposed on their edges on a substrate.

5. The carbon nanoflake composition of claim 1, wherein the plurality of carbon nanoflakes are aligned.

6. The carbon nanoflake composition of claim 1, further comprising a coating, wherein said coating is selected from the group consisting of Pt, Ni, Ti, Zr, Hf, V, Nb, Mo, Ta, ZrC, and oxides and alloys thereof.

7. A method of making carbon nanoflakes comprising forming said nanoflakes on a substrate using RF-PECVD, wherein the CVD source gas used to grow the nanoflakes during the RF-PECVD process contains an acetylene to hydrogen ratio of between 63:37 and 100:0.

8. The method of claim 7, wherein RF-PECVD is inductively coupled.

9. The method of claim 7, wherein the substrate temperature is between 500° C. and 700° C.

10. The method of claim 7, wherein the RF-PECVD chamber pressure is between 20 mtorr and 200 mtorr.

11. The method of claim 7, wherein the RF-PECVD plasma power is equal to or greater than 700 W.

12. The method of claim 7, wherein alignment of the carbon nanoflakes is modified by applying an external, time-varying electromagnetic field to the substrate.

13. The method of claim 12, wherein the substrate is connected through variable resistance paths to ground.

14. The method of claim 12, wherein a constant electric potential is applied to the substrate.

15. The method of claim 12, wherein a time-varying electric potential is applied to the substrate.

16. The method of claim 12, wherein the substrate is exposed to a polarized light source.
